(19) United States
(12) Patent Application Publication
(10) Pub. No.: US 2025/0353204 A1
(43) Pub. Date: Nov. 20, 2025

(54) FOOD PRODUCT SLICER INTERLOCK FOR TRAY SYSTEM

(71) Applicant: ILLINOIS TOOL WORKS INC., Glenview, IL (US)

(72) Inventor: Matthew W. BIRD, Xenia, OH (US)

(21) Appl. No.: 19/186,227

(22) Filed: Apr. 22, 2025

Related U.S. Application Data
(60) Provisional application No. 63/647,300, filed on May 14, 2024.

(51) Int. Cl. B26D 7/01; B26D 7/00; B26D 7/26

(52) U.S. Cl. CPC B26D 7/01; B26D 7/26; B26D 2007/0018; B26D 2210/02

(57) ABSTRACT

A food product slicer includes a base, a knife mounted for rotation, and a carriage assembly mounted to the base for movement back and forth past a cutting edge of the knife, with a tray is removably connected to a tray mount of a tray arm. A movable gauge plate is provided for varying slice thickness, and a gauge plate indexing assembly is provided for moving the gauge plate between a closed position and multiple open positions. An interlock assembly is provided between the tray mount and the gauge plate indexing assembly, wherein the interlock assembly comprises a tension only cable system that is configured to (i) prevent removal of the tray from the tray mount unless the gauge plate is in the closed position and (ii) prevent movement of the gauge plate out of the closed position when the tray is removed from the tray mount.

### TECHNICAL FIELD

This application relates generally to food product slicers of the type commonly used to slice bulk food products and, more specifically, to a tension only interlock for a tray system, or other component(s), in such a food product slicer.

### BACKGROUND

Typical reciprocating food slicers have a rotatable, circular or disc-like slicing blade, an adjustable gauge plate for varying the thickness of the slice and a carriage for supporting the food as it is moved back and forth past the cutting edge of the knife during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife for varying the thickness of the slices to be cut. A rotatable adjustment or indexing knob is provided manually for setting a spacing between the plane of the gauge plate surface and the plane of the knife edge for the purpose of slicing so that operators can select a thickness of slices to be produced.

Slicer tray arms mount the product holding tray of the carriage to a transport. Many of them allow the product tray to tilt down for easy cleaning. Some allow the tray to be removed from the tray arm for cleaning. The gauge plate interlock is a mechanism in slicers that interlocks the gauge plate indexing system with the product tray system. The interlock will not allow the product tray to be tilted/removed if the gauge plate indexing system is exposing the knife edge for cutting (gauge plate needs to be set at the home or closed position); and the interlock will not allow the gauge plate indexing system to open up and expose the knife edge if the product tray is tilted/removed. The intent of this interlock system is to prevent unnecessary knife exposure when the product tray is removed or tilted for cleaning.

Some solutions force the interlock to only occur when the carriage is in a known location (usually the home or forward position) which lowers the design difficulty, but generally leads to an unintuitive function for the operator. Other solutions that allow this interlock to operate throughout the entire stroke of the carriage generally require more parts with more difficult assembly, resulting in more cost, to carry out the interlock at all carriage locations.

U.S. Pat. No. 7,637,191 discloses a clever way to transmit an interlock control between two parts of a machine that are not stationary relative to each other (e.g., the gauge plate indexing system and the moving tray). The described system has some drawbacks in that, in production, the design ends up being quite expensive. Further, the system only works if the index system is not using the index knob cam surface for gauge plate actuation. The biggest reason for the expense of the referenced prior art design is due to the interlock logic which necessitates a push/pull control cable. Further, the prior art necessitates two sets of control cables that transmit the interlock logic through an intermediary bar, which is fairly complex.

Accordingly, it would be desirable to provide a slicer with an improved tray system interlock.

### SUMMARY

In one aspect, a food product slicer includes a base and a knife mounted for rotation relative to the base. A carriage assembly is mounted to the base for reciprocal movement back and forth past a cutting edge of the knife, wherein the carriage includes a tray mounted to a tray mount of a tray arm, and the tray is removably connected in a use position to the mount. A movable gauge plate is provided for varying a thickness of food product slices, and a gauge plate indexing assembly is provided for moving the gauge plate between a closed position and multiple open positions. An interlock assembly is provided between the tray mount and the gauge plate indexing assembly, wherein the interlock assembly comprises a tension only cable system that is configured to (i) prevent removal of the tray from the tray mount unless the gauge plate is in the closed position and (ii) prevent movement of the gauge plate out of the closed position when the tray is removed from the tray mount.

In one implementation of the preceding paragraph, the tension only cable system includes a single cable with a first end connected to interact with part of the gauge plate indexing assembly and a second end configured to interact with part of a mount for the tray.

In one implementation of the preceding paragraph, the first end is biased with a first bias to place tension on the single cable and the second end is biased with a second bias to place tension on the single cable, wherein a second bias applied to the second end is greater than a first bias applied to the first end.

In one implementation of the preceding paragraph, the first end is connected to a lever arm that is arranged to axially move, or allow axial movement, of a locking pin when the lever arm rotates, and a spring applies the first bias that urges the locking pin out of a gauge plate locking position.

In one implementation of the preceding paragraph, the second end is connected to a cam disc that has an associated spring that urges rotation of the cam disc to apply the second bias to the second end.

In one implementation of the preceding paragraph, when the tray is in the use position, the cam disc is in a first rotational position, wherein, in order to remove the tray from the tray mount, the cam disc must rotate from the first rotational position, in a direction with the second bias, and into a second rotational position.

In one implementation of any of the preceding aspect or implementations, the tension only cable system includes a cable with a first end connected to a first component and a second end connected to a second component, wherein the first component is biased to pull the cable in tension and the second component is biased to pull the cable in tension.

In one implementation of the preceding paragraph, the first component is a pivotable lever and the second component is a rotatable cam disc.

In one implementation of the preceding paragraph, wherein the lever is connected to selectively move a further component into a position to lock the gauge plate in the closed position, wherein the cam disc is engaged with part of the tray when the tray is in the use position.

In one implementation of the preceding aspect of preceding implementations, a first spring biases the first component and a second spring biases the second component.

In one implementation of the preceding paragraph, the second spring and the second component are configured such that a second tension bias on the second end is greater than a first tension bias on the first end.

In one implementation of any of the preceding aspect ore preceding implementations, a releasable locking assembly is provided for holding the tray in the use position, wherein the releasable locking assembly comprises a push-button on the tray arm that is configured to release a lock of the tray when the push-button is depressed.

In another aspect, a method is provided for interlocking a tray mount and a gauge plate indexing assembly of a food product slicer that includes a knife mounted for rotation, a carriage assembly movable back and forth past a cutting edge of the knife, wherein the carriage assembly includes the tray removably connected in a use position to a tray arm, wherein a movable gauge plate enables varying a thickness of food product slices and the gauge plate indexing assembly enables movement of the gauge plate between a closed position and multiple open positions. The method involves: providing an interlock cable with a first end and a second end, wherein the first end is associated with the gauge plate indexing assembly and the second end is associated with the tray mount; and biasing the first end of the cable in tension and biasing the second end of the cable in tension.

In one implementation of preceding paragraph, a bias applied to the second end of the cable is greater than a bias applied to the first end of the cable.

### BRIEF DESCRIPTION OF DRAWINGS

FIGS. 1 and 2 show a food product slicer;

FIGS. 3-4 show schematic views of an interlock system;

FIGS. 5-6 show portions of a index side of a first embodiment of the interlock system;

FIGS. 7-11 show portions of a tray side of the first embodiment of the interlock system;

FIGS. 12-13 show portions of an index side of a second embodiment of the interlock system;

FIGS. 14-17 show portions of a tray side of the second embodiment of the interlock system;

FIG. 18 shows part of a cable routing path of the second embodiment;

FIG. 19 shows a tray locking/latching feature of the second embodiment.

### DETAILED DESCRIPTION

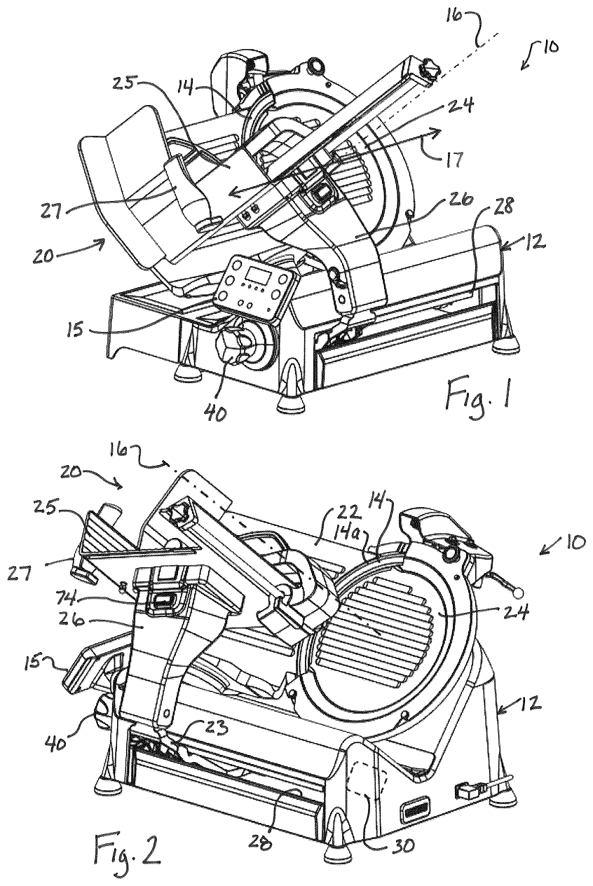

Referring to FIGS. 1-2, a food product slicer 10 includes a base 12 (e.g., housing and/or frame) and a circular, motor-driven slicing knife 14 that is mounted to the housing for rotation about an axis 16. The left side of FIG. 1, where the controls (e.g. user interface 15) are located, is generally referred to as the front side of the slicer (which is where an operator stands for slicing), the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates back and forth along a linear path 17 so that the lower end of the bulk food product slides along the surface of a gauge plate 22, is cut by the knife 14 and then slides along a knife cover plate 24. The food carriage 20 includes a tray 25 mounted to a tray mount of a tray arm 26 that is mounted on a transport 23 and that orients the food carriage tray at the appropriate angle (typically perpendicular) to the knife cutting-edge plane. The food carriage arm reciprocates along a slot 28 at a lower portion of the housing 12. The carriage 20 can be moved manually (e.g., by a handle 27) and/or the carriage 20 may also be automatically driven (e.g., as by an internal motor 30 that drives a belt that is linked internally to a transport to which the arm 26 is pivotably connected). A gauge plate system includes a rotatable knob 40 (connected to an opening in the base 12).

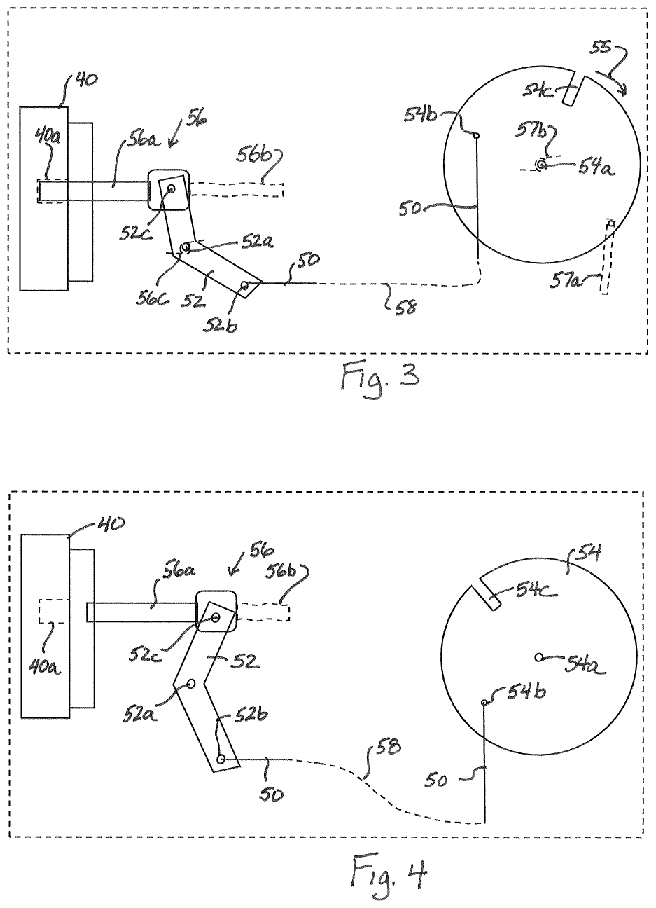

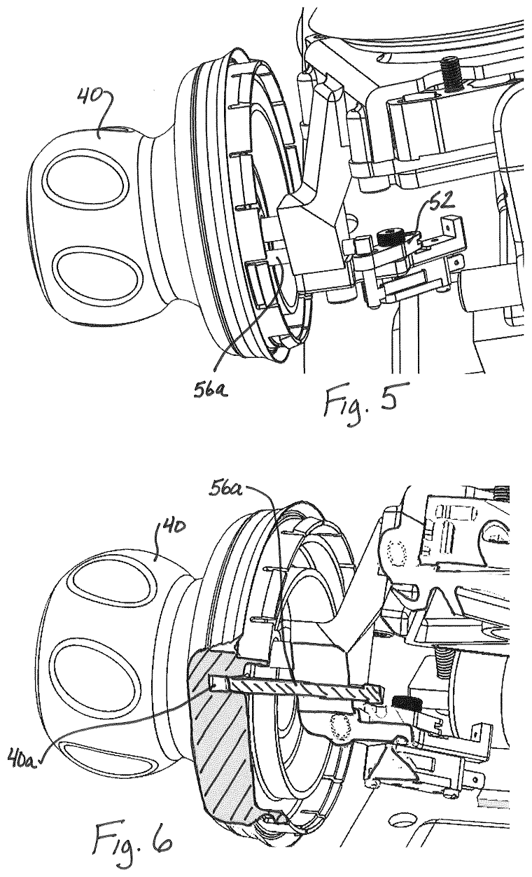

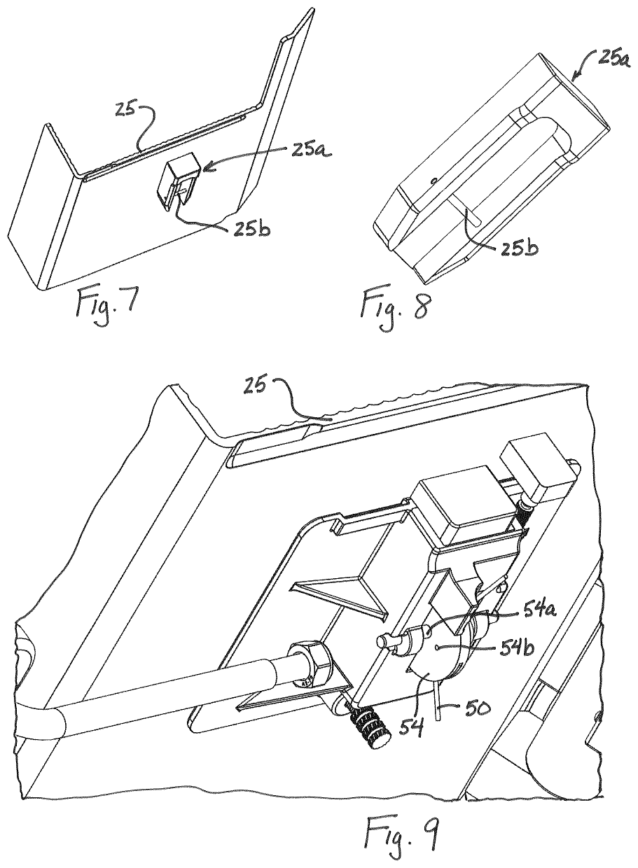

The interlock is provided between the gauge plate system and the tray 25 or tray mount. As shown schematically in FIGS. 3 and 4, the interlock has two sides attached by a control cable 50. Here, the cable extends between a lever arm 52 and a cam disc 54. The lever arm 52 includes a fixed position pivot axis 52a along a middle portion of the arm, a pivot connection 52b for one end of the cable and a pivot connection 52c to a pin unit 56, such that pivot or rotation of the lever arm 52 axially moves, or allows axial movement of, a pin 56a of the pin unit. A spring (e.g., tension spring 56b or torsion spring 56c) biases the pin in a direction that places tension on the cable (e.g., by urging the pin to the right in the schematic of FIG. 3, which urges clockwise rotation of the lever arm 52 about axis 52a). The cam disc 54 is mounted for rotation about an axis 54a and includes a pivot connection 54b for the other end of the cable and a peripheral slot 54c. A spring bias (e.g., provided by a tension spring 57a or a torsion spring 57b) applied to the cam disc 54 urges rotation of the cam disc 54 in a direction 55 that places tension on the cable. The cam disc 54 moves with the food product carriage, and therefore a distance between the pivot connection 52b and the pivot connection 54b varies continuously during movement of the food product carriage. Accordingly, a path 58 of the cable 50 includes slack cable that can flex to accommodate the movement. The cable 50 may comprise a wire that runs within a cable sheath.

The interlock mechanism has two states. State 1 (FIG. 3) occurs when the mechanism is left alone with no outside interference. In state 1, the cam disc spring 57a/57b rotates the cam disc 54 fully clockwise. This clockwise rotation pulls the cable and overcomes the pin spring force. Note that the right side of the schematic of FIG. 3, state 1, the cable 50 is being pulled upwards during the rotation—this in turn pulls the control cable 50 and results in a rightward movement of the control cable in the left side of the state 1 image.

To move from state 1 (FIG. 3) to state 2 (FIG. 4), an outside interference must occur. If the cam disc spring bias is overpowered and the cam disc 54 is rotated fully counterclockwise, the control cable 50 will be loosened/slackened at the lever arm end. With the cam disc spring bias overcome, the pin spring 56b/56c will now maintain tension on the cable and move the pin as pictured in the state 2 images.

The cam disc spring bias can be overcome by applying sufficient force to rotate the cam disc 54 (this allows the index side to move the mechanism to state 2). Physically, this is manifested as installing the product tray. Removing the product tray will remove this outside intervention. The other outside intervention is if the pin 56a is physically stopped from moving axially to the left. If there is a wall placed in front of the pin 56a, it will not be possible to move from state 2 to state 1. Physically, this is manifested as the index knob lock recess 40a not lining up with the pin (meaning the index knob is not at its zero position in which the gauge plate is closed to guard the knife cutting edge with the gauge plate). This will prevent the cam disc from rotating and allowing the product tray to be removed, whenever the pin 56a cannot move to the state 1 position (because the gauge plate is not closed).

More specifically, in state 1, the pin 56a is engaged with or into a feature (e.g. recess 40a) of the gauge plate indexing system, such that the indexing system cannot be adjusted. The pin 56a aligns with this feature only when the gauge plate is fully closed. In state 2, the pin is disengaged or retracted from the feature, which enables the gauge plate position to be adjusted by rotation of the knob 40. To move from state 2 to state 1, the cam disc 54 must be rotated to pull the lever arm 52 and move the pin 56a into the feature 40a of the gauge plate indexing system. Here, this occurs by removing the tray 25 from the mount platform 26a of the gauge plate arm 26, such that the spring-bias on the cam disc will urge the cam disc into, and hold the cam disc in, the state 1 position. The tray 25 can only be removed from the tray arm when the cam disc 54 is capable of moving to the state 1 position, which only occurs when the gauge plate is closed. To move from state 1 (FIG. 3) to state 2 (FIG. 4), the tray 25 is attached to the tray arm 26 and, during this process, the tray includes a feature that engages into the cam disc slot 54c and forces the counterclockwise rotation of the cam disc 54 against the bias of the cam disc spring. This allows the lever arm 52 to rotate so as to retract the pin 56a from the feature 40a, allowing the gauge plate to be opened to allow slicing and vary slice thickness.

Another way to explain the operation of this mechanism is as follows: the index side of the mechanism (left side in state 1 and state 2) is always trying to move the pin from state 1 to state 2 (due to the action of the spring 56b/56c). The cam side of the mechanism (right side in state 1 and state 2) is always trying to get to the state 1 position (due to the spring force on the cam disc). The bias applied by the cam disc spring is designed to be mechanically stronger than the bias of the pin spring, and thus overcomes the pin spring by default. So state 2 is only achieved when the stronger cam spring is overcome by a user mounting the tray onto the tray arm.

Referring to FIGS. 5-6, portions of the index side of a first embodiment of the interlock are shown, including the lever arm 52 and pin 56a engaged into a feature in the form of a hole or recess 40a at the inward side of the knob 40. This is the state 1 engagement that prevents rotation of the knob 40.

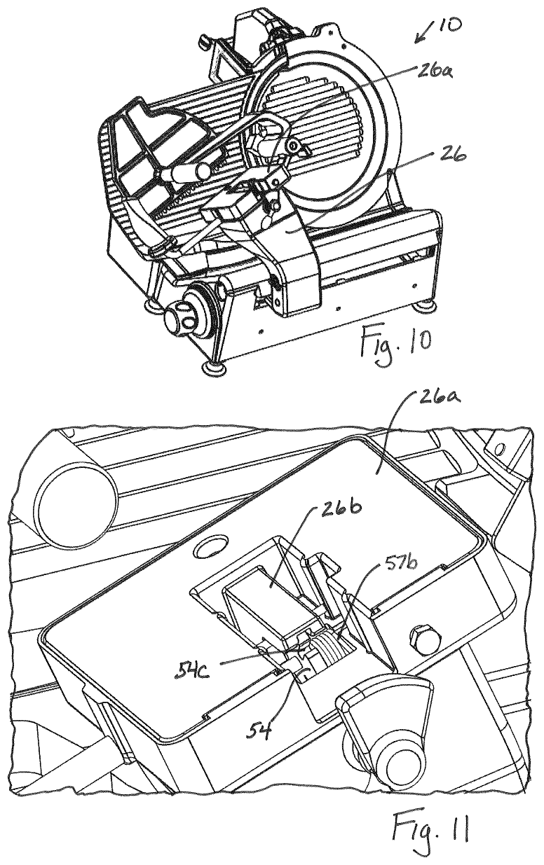

Referring to FIGS. 7-11, portions of the tray side of the first embodiment of the interlock are shown, with the bottom or mount side of the tray 25 including a mount feature 25a that includes a pin 25b that will engage into the aforementioned slot 54c of the cam disc 54 to force the interlock into the state 2 position when the tray is mounted to the tray mount of the tray arm and the cam disc 54 is forced to rotate against the bias of the cam disc spring 57b. As the cam disc 54 rotates into the state 2 position, the slot 54c, with tray pin 25b positioned therein, moves beneath a capture finger 26b within a slot, recess or gap of the mount platform 26a of the tray mount, such that the tray cannot be removed from the tray mount by pulling the tray arm upwardly away from the platform 20a. The mount feature 25a slides into and out of the open end of the slot of the mount platform 26a for the purpose of tray install and removal.

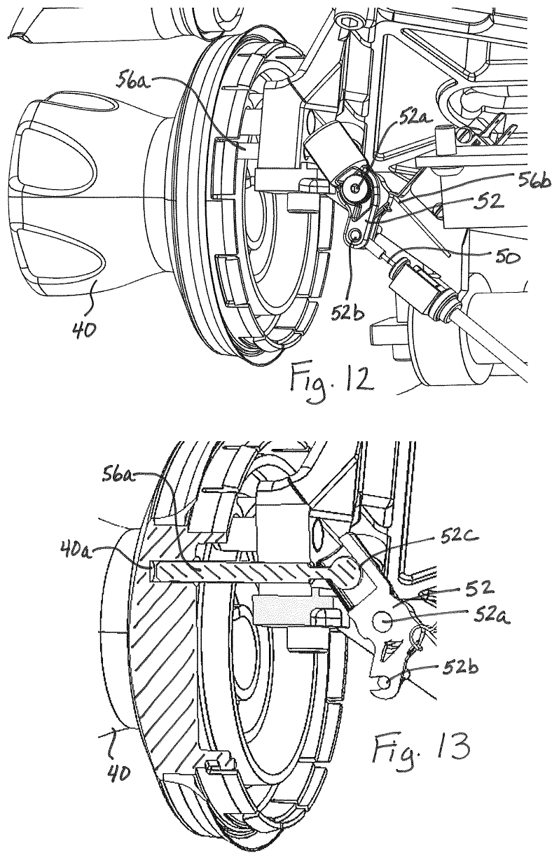

Referring to FIGS. 12-13, portions of the index side of a second embodiment of the interlock are shown, including the lever arm 52 and pin 56a engaged into a feature in the form of a hole or recess 40a at the inward side of the knob 40. Spring 56c (here a torsion spring) is also shown, along with the pivot connections 52a, 52b and 52c. This is the state 1 engagement that prevents rotation of the knob 40.

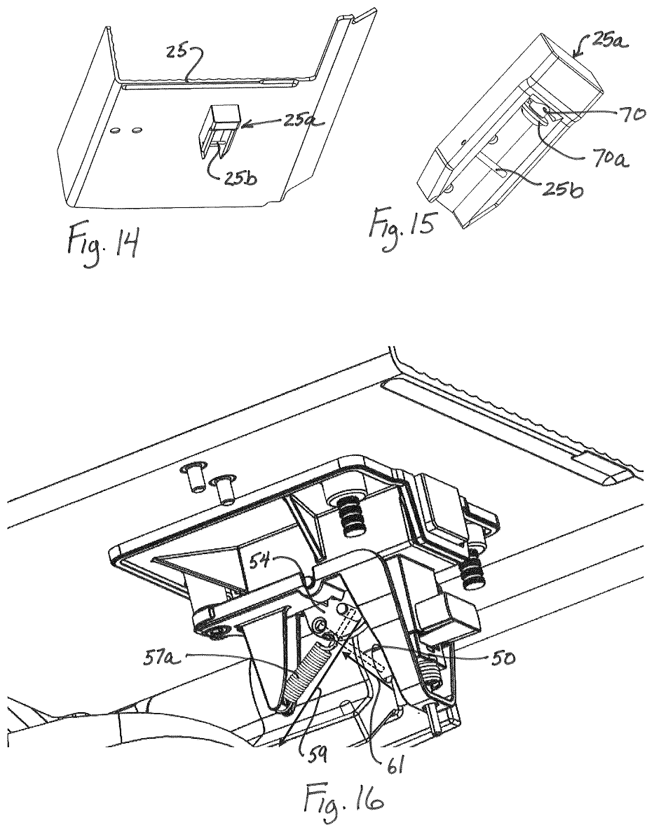

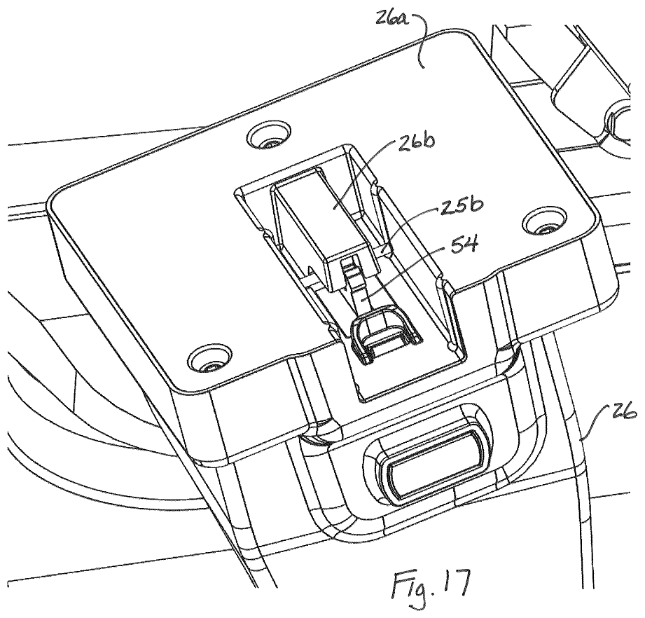

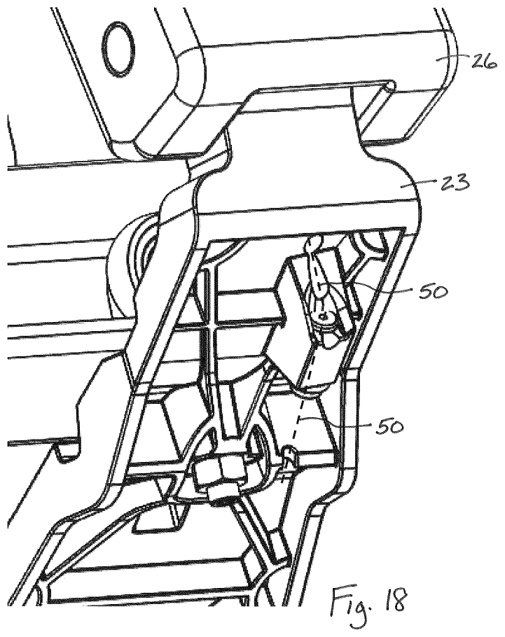

Referring to FIGS. 14-17, portions of the tray side of the second embodiment of the interlock are shown, with the bottom or mount side of the tray 25 including a mount feature 25a (e.g., a bracket with a downwardly facing slot) that includes a pin 25b that will engage into the aforementioned slot 54c of the cam disc 54 to force the interlock into the state 2 position when the tray is mounted onto the arm and the cam disc 54 is forced to rotate against the bias of the cam disc spring 57a. As the cam disc 54 rotates into the state 2 position, the slot 54c, with tray pin 25b positioned therein, moves beneath a capture finger 26b within a recess or gap of the mount platform 26a, such that the tray cannot be removed from the tray arm by pulling the tray arm upwardly away from the platform 20a. As shown, the cam disc spring 57a operates with a pulling force in direction 59 on the cam disc 54, such that the cam disc 54 places a tension force, per direction 61, on the cable 50.

Although the exact routing of the cable between the two end points is not critical, per the second embodiment, as shown in FIG. 18, the intermediate portion of the cable 50 maybe routed through passages in the transport 23 to reach the tray side.

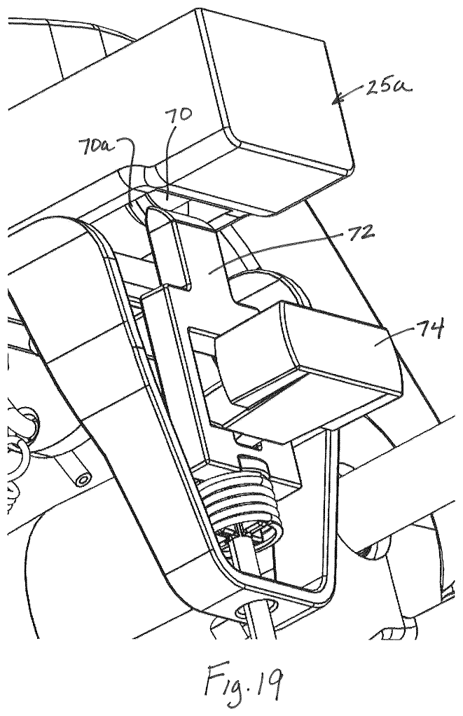

As seen in FIGS. 15 and 19, a releasable locking assembly for the tray is provided. Here, the mount feature 25a also carries a shaft 70 with enlarged head 70a for the purposed of releasable locking of the tray on the mount platform 26a. Per FIG. 19, the mount arm 26 includes an internal latch bar 72 that is upwardly biased into a position such that, when the tray is in its use position, the upper edge of the latch bar 72 is positioned to interact with the head 70a to prevent the tray from sliding in the removal direction. A push-button 74 on the arm can be depressed to temporarily move the latch bar 72 downward to allow tray removal (if the gauge plate is in the closed position).

Advantages provided by the described interlock system(s) include being (i) cost effective due to tension-only control cables and/or (ii) simple since there is only one control cable and/or (iii) intuitive to the operator because there is no need to bring the carriage to the home position to remove the product tray.

It is to be clearly understood that the above description is intended by way of illustration and example only and is not intended to be taken by way of limitation. Variations are possible.

1. A food product slicer, comprising:
a base;
a knife mounted for rotation relative to the base;
a carriage assembly mounted to the base for reciprocal movement back and forth past a cutting edge of the knife, wherein the carriage includes a tray mounted to a tray mount of a tray arm, and the tray is removably connected in a use position to the mount;
a movable gauge plate for varying a thickness of food product slices;
a gauge plate indexing assembly for moving the gauge plate between a closed position and multiple open positions;
an interlock assembly between the tray mount and the gauge plate indexing assembly, wherein the interlock assembly comprises a tension only cable system that is configured to (i) prevent removal of the tray from the tray mount unless the gauge plate is in the closed position and (ii) prevent movement of the gauge plate out of the closed position when the tray is removed from the tray mount.

2. The food product slicer of claim 1, wherein the tension only cable system includes a single cable with a first end connected to interact with part of the gauge plate indexing assembly and a second end configured to interact with part of a mount for the tray.

3. The food product slicer of claim 2, wherein the first end is biased with a first bias to place tension on the single cable and the second end is biased with a second bias to place tension on the single cable, wherein a second bias applied to the second end is greater than a first bias applied to the first end.

4. The food product slicer of claim 3, wherein the first end is connected to a lever arm that is arranged to axially move, or allow axial movement, of a locking pin when the lever arm rotates, and a spring applies the first bias that urges the locking pin out of a gauge plate locking position.

5. The food product slicer of claim 4, wherein the second end is connected to a cam disc that has an associated spring that urges rotation of the cam disc to apply the second bias to the second end.

6. The food product slicer of claim 5, wherein, when the tray is in the use position, the cam disc is in a first rotational position, wherein, in order to remove the tray from the tray mount, the cam disc must rotate from the first rotational position, in a direction with the second bias, and into a second rotational position.

7. The food product slicer of claim 1, wherein the tension only cable system includes a cable with a first end connected to a first component and a second end connected to a second component, wherein the first component is biased to pull the cable in tension and the second component is biased to pull the cable in tension.

8. The food product slicer of claim 7, wherein the first component is a pivotable lever and the second component is a rotatable cam disc.

9. The food product slicer of claim 8, wherein the lever is connected to selectively move a further component into a position to lock the gauge plate in the closed position, wherein the cam disc is engaged with part of the tray when the tray is in the use position.

10. The food product slicer of claim 7, further comprising:
wherein a first spring biases the first component and a second spring biases the second component.

11. The food product slicer of claim 10, wherein the second spring and the second component are configured such that a second tension bias on the second end is greater than a first tension bias on the first end.

12. The food product slicer of claim 1, further comprising:
a releasable locking assembly for holding the tray in the use position, wherein the releasable locking assembly comprises a push-button on the tray arm that is configured to release a lock of the tray when the push-button is depressed.

13. A method of interlocking a tray mount and a gauge plate indexing assembly of a food product slicer that includes a knife mounted for rotation, a carriage assembly movable back and forth past a cutting edge of the knife, wherein the carriage assembly includes the tray removably connected in a use position to a tray arm, wherein a movable gauge plate enables varying a thickness of food product slices and the gauge plate indexing assembly enables movement of the gauge plate between a closed position and multiple open positions, wherein the method involves:
providing an interlock cable with a first end and a second end, wherein the first end is associated with the gauge plate indexing assembly and the second end is associated with the tray mount; and
biasing the first end of the cable in tension and biasing the second end of the cable in tension.

14. The method of claim 13, wherein a bias applied to the second end of the cable is greater than a bias applied to the first end of the cable.
